(19) United States
(12) Patent Application Publication
(10) Pub. No.: US 2019/0080681 A1
(43) Pub. Date: Mar. 14, 2019

(54) NOISE REDUCTION DEVICE, VEHICLE, AND NOISE REDUCTION METHOD

(71) Applicant: PANASONIC INTELLECTUAL PROPERTY MANAGEMENT CO., LTD., Osaka (JP)

(72) Inventor: Yoshiyuki HAYASHI, Osaka (JP)

(73) Assignee: PANASONIC INTELLECTUAL PROPERTY MANAGEMENT CO., LTD., Osaka (JP)

(21) Appl. No.: 16/128,130

(22) Filed: Sep. 11, 2018

(30) Foreign Application Priority Data
Sep. 12, 2017 (JP) 2017-175035

(51) Int. Cl. G10K 11/178

(52) U.S. Cl. CPC G10K 11/17854; G10K 2210/1282

(57) ABSTRACT

A noise reduction device reduces noise at a second position by using a canceling sound emitted from a first position. The noise reduction device corrects, to a second transfer characteristic, a first transfer characteristic for when the first position and the second position are in a reference positional relationship, according to a signal indicating the positional relationship between the first position and the second position, and corrects a base signal based on the second transfer characteristic.

### CROSS REFERENCE TO RELATED APPLICATION

The present application claims the benefit of Japanese Patent Application No. 2017-175035 filed Sep. 12, 2017. The entire disclosure of the above-identified application, including the specification, drawings and claims is incorporated herein by reference in its entirety.

### FIELD

The present disclosure relates to a noise reduction device and the like which actively reduce noise.

### BACKGROUND

Conventionally, a noise reduction device which actively reduces noise at a hearing position by emitting sound for canceling out the noise from a speaker is known. As the noise reduction device described above, for example, an active noise canceler is disclosed in Patent Literature 1.

### CITATION LIST

### Patent Literature

[PLT1] Japanese Patent No. 5829052

### SUMMARY

### Technical Problem

However, the noise reduction device according to PTL 1 described above can be improved upon. In view of this, the present disclosure provides a noise reduction device, vehicle, and noise reduction method capable of improving upon the above related art.

### Solution to Problem

A noise reduction device according to an aspect of the present disclosure is a noise reduction device which reduces noise at a second position by using a canceling sound emitted from a first position and includes: a first input terminal to which a noise reference signal having correlation with the noise is input; a base signal generator which generates a base signal having a frequency identified based on the noise reference signal that has been input; an adaptive filter unit which generates an output signal used for emission of the canceling sound, by applying a filter coefficient to the base signal that has been generated; an output terminal to which the output signal that has been generated is output; a second input terminal to which an error signal based on a residual sound generated at the second position due to interference between the canceling sound and the noise is input; a third input terminal to which a signal indicating a positional relationship between the first position and the second position is input; a corrector which corrects a first transfer characteristic to a second transfer characteristic, according to the signal indicating the positional relationship, and corrects the base signal based on the second transfer characteristic, the first transfer characteristic being a transfer characteristic for when the first position and the second position are in a reference positional relationship; and a filter coefficient updater which updates the filter coefficient based on the error signal that has been input and the base signal that has been corrected.

A vehicle according to an aspect of the present disclosure includes: the noise reduction device; a sound emission device which is disposed at the first position and outputs the canceling sound using the output signal; and a sound collection device which is disposed at the second position and outputs the error signal to the second input terminal.

A noise reduction method according to an aspect of the present disclosure is a noise reduction method of reducing noise at a second position by using a canceling sound emitted from a first position, and includes: generating a base signal having a frequency identified based on a noise reference signal having correlation with the noise; generating an output signal used for emission of the canceling sound, by applying a filter coefficient to the base signal that has been generated; correcting a first transfer characteristic to a second transfer characteristic, according to a signal indicating a positional relationship between the first position and the second position, and correcting the base signal based on the second transfer characteristic, the first transfer characteristic being a transfer characteristic for when the first position and the second position are in a reference positional relationship; and updating the filter coefficient based on an error signal based on a residual sound generated at the second position due to interference between the canceling sound and the noise, and the base signal that has been corrected.

### Advantageous Effects

The noise reduction device and the like, the vehicle, and the noise reduction method according to the present disclosure can achieve further improvement.

### BRIEF DESCRIPTION OF DRAWINGS

These and other objects, advantages and features of the present disclosure will become apparent from the following description thereof taken in conjunction with the accompanying drawings that illustrate a specific embodiment of the present disclosure.

FIG. 1 is a diagram illustrating an outline of a noise reduction device according to an embodiment.

FIG. 2 is a schematic diagram illustrating a time waveform of noise heard at the position of a microphone.

FIG. 3 is a schematic diagram of a car including the noise reduction device according to the embodiment.

FIG. 4 is a functional block diagram of the noise reduction device according to the embodiment.

FIG. 5 is a flowchart of a basic operation of the noise reduction device according to the embodiment.

FIG. 6 is a diagram illustrating the coordinates of the second position when the backrest of the seat is tilted relative to the seating surface.

FIG. 7 is a diagram illustrating the coordinates of the second position when the seat position is shifted in the forward-backward direction.

FIG. 8 is a flowchart of the correction of a first transfer characteristic.

### DESCRIPTION OF EMBODIMENT

Hereinafter, embodiments will specifically be described with reference to the drawings. The embodiments described below each illustrate a particular example of the present disclosure. Thus, the numerical values, shapes, materials, elements, the arrangement and connection of the elements, steps, the order of the steps, etc., indicated in the following embodiments are mere examples, and are not intended to limit the present disclosure. Therefore, among the elements in the following embodiments, elements not recited in any of the independent claims defining the most generic concept of the present disclosure are described as optional elements.

Furthermore, the drawings are schematic and do not necessarily provide precise depictions. Throughout the drawings, like elements share like reference signs and redundant description is omitted or simplified.

### Embodiment

[Outline]

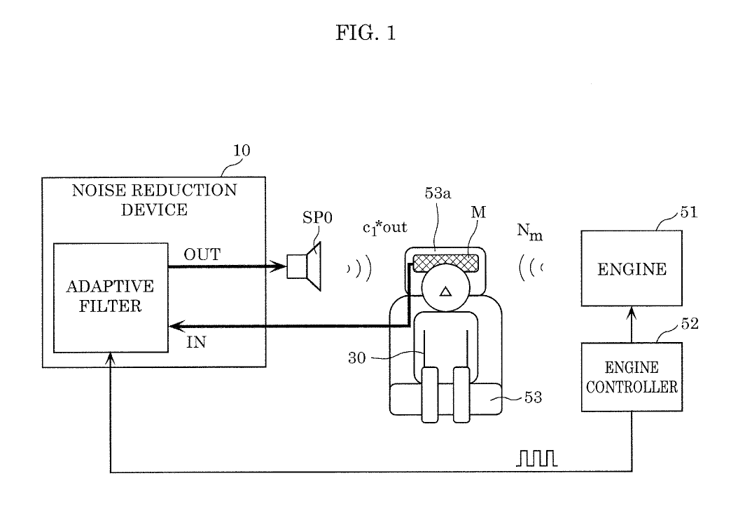

First, an outline of a noise reduction device according to an embodiment will be described. First, FIG. 1 is a diagram illustrating the outline of the noise reduction device according to the embodiment.

Noise reduction device 10 illustrated in FIG. 1 is a device which is, for example, installed inside the cabin of an automobile and reduces noise generated during movement of the automobile. Instantaneously, the noise caused by engine 51 is a sound close to a single-frequency sine wave. Therefore, noise reduction device 10 obtains a pulse signal which indicates the frequency of engine 51 from engine controller 52 which controls engine 51, and emits a canceling sound from speaker SP0 for canceling out the noise. An adaptive filter is used for generating the canceling sound, and the canceling sound is generated so that a residual sound collected by microphone M disposed near hearer 30 is reduced.

As illustrated in FIG. 1, a first transfer characteristic from the position of speaker SP0 (hereinafter, also referred to as a sound emission position or a first position) to the position of microphone M (hereinafter, also referred to as a sound collection position or a second position) is denoted by “c₁”, and an output signal for emitting the canceling sound is denoted by “out”. In this case, the canceling sound reaching the position of microphone M (sound collection position) is denoted by “c₁*out”. It should be noted that “k” denotes a convolution operator, c₁ denotes an impulse response of the transfer characteristic, and C₁ denotes the transfer characteristic in the frequency region.

When the amplitude is denoted by R, angular frequency by ω, and phase by θ, noise Nₘ at the position of microphone M is expressed by (Equation 1) below, and c₁*out is expressed by (Equation 2-1), (Equation 2-2) below. Noise reduction device 10 can emit the canceling sound for canceling out the noise by calculating filter coefficient A and filter coefficient B in (Equation 2-1), (Equation 2-2) using the least mean square (LMS) method, for example.

[Math. 1]

Nₘ=R·sin(ωt+θ)

c₁*out=R·sin[ωt+(θ−π)] (Equation 1)

when C₁=1,

out=R·sin[ωt+(θ−π)]=A·sin(ωt)+B·cos(ωt)

where R=\sqrt{A²+B²},θ−π=tan⁻¹(B/A) (Equation 2-1)

when C₁≠1

c₁*out=R·sin[ωt+(θ·π)]=A′·sin(ωt)+B′·cos(ωt)

where

R=\sqrt{A′²+B′²},θ−π=tan⁻¹B′/A′),

A′+jB′=C₁(ω)(A+jB) (Equation 2-2)

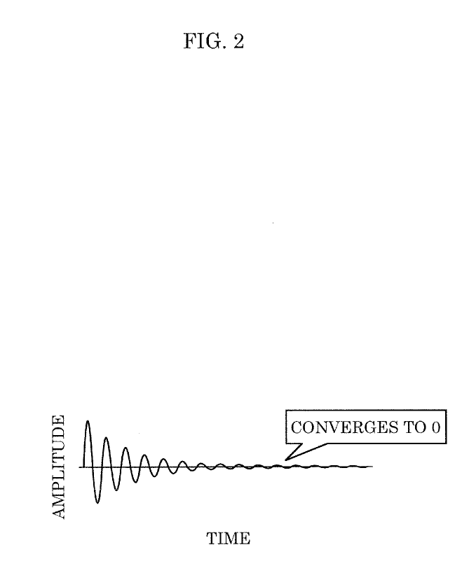

Because of the emission of the canceling sound having the opposite phase to noise Nₘ as described above, the noise that can be heard at the position of microphone M becomes smaller, as illustrated in FIG. 2. FIG. 2 is a schematic diagram illustrating a time waveform of the noise heard at the position of microphone M.

By the way, for example, microphone M is installed near the ears of hearer 30. For example, microphone M is disposed in backrest upper portion 53a of seat 53. In this case, when at least one of the position and the incline of seat 53 changes, the positional relationship between the first position of speaker SP0 and the second position of microphone M changes. If the canceling sound is emitted using first transfer characteristic C₁ optimized based on the reference positional relationship, when the first position of speaker SP0 and the second position of microphone M changes from a predetermined reference positional relationship, it is possible that a sufficient reduction effect cannot be obtained. Therefore, noise reduction device 10 is intended to improve noise reduction effect in the case where the second position of microphone M changes, by correcting first transfer characteristic C₁.

[Overall Configuration of Car Including Noise Reduction Device]

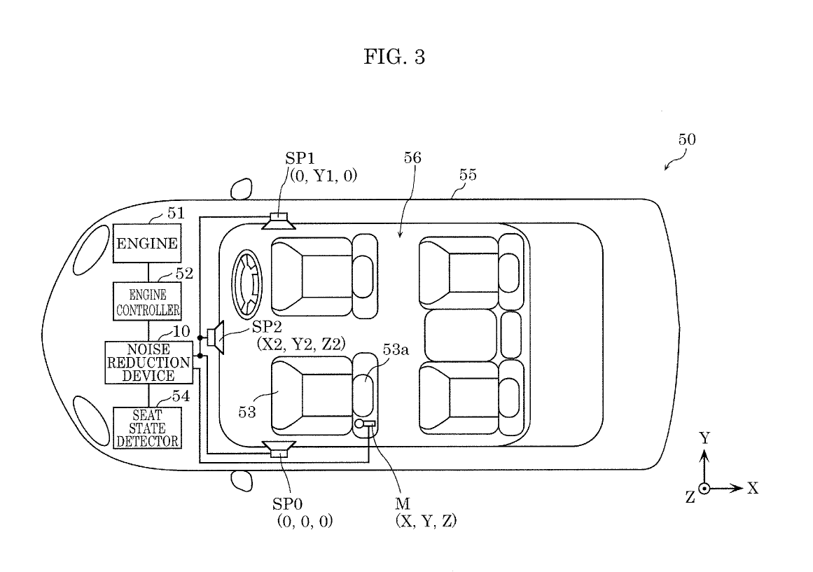

Hereinafter, noise reduction device 10 described above will be described in more detail. In the embodiment, noise reduction device 10 is mounted on a car as an example. FIG. 3 is a schematic diagram of a car including noise reduction device 10.

Car 50 which is an example of a vehicle, includes noise reduction device 10, engine 51, engine controller 52, speaker SP0, speaker SP1, speaker SP2, microphone M, seat 53, seat state detector 54, and car body 55. Car 50 is specifically an automobile, but not particularly limited.

Engine 51 is a power source of car 50, and is a drive unit which is a noise source of space 56. Engine 51 is disposed, for example, in a different space from space 56. Specifically, engine 51 is installed in a space formed in the engine compartment of car body 55.

Engine controller 52 controls (drives) engine 51 according to the gas pedal operation, etc. of the driver of car 50. Furthermore, engine controller 52 outputs a pulse signal (engine pulse signal), as a noise reference signal, according to the rotating speed (frequency) of engine 51. The frequency of the pulse signal is proportion to the rotating speed (frequency) of engine 51, for example. Specifically, the pulse signal is an output signal of a top dead center (TDC) sensor or a so-called tachometer pulse. It should be noted that the noise reference signal may be in any mode as long as the noise reference signal has correlation with the noise.

Speaker SP0 is an example of a sound emission device, and is a speaker which emits the canceling sound, using an output signal. Speaker SP0 is positioned near the door on the front passenger seat side in space 56, but the first position of speaker SP0 is not particularly limited. Each of speaker SP1 positioned near the door on the driver seat side and speaker SP2 disposed on the dashboard is a speaker which emits the canceling sound, using an output signal, as with speaker SP0. In the embodiment, the position of speaker SP0, the position of speaker SP1, and the position of speaker SP2 are fixed.

Microphone M is an example of a sound collection device, and collects a residual sound generated at the second position due to interference between the canceling sound and the noise. Furthermore, microphone M outputs an error signal based on the collected residual sound. Microphone M is attached to backrest upper portion 53a of seat 53 in space 56. The second position of microphone M is not particularly limited. Backrest upper portion 53a may be a headrest.

Seat 53 is a location where hearer 30 is seated in car 50. Seat 53 has a mechanism that enables the position in the forward-backward direction (specifically, the position in the X-axis direction) to be changed. Seat 53 may further have a mechanism that enables the position in the height direction (specifically, the position in the Z-axis direction) to be changed.

Furthermore, seat 53 has a mechanism that enables the angle of the backrest relative to the seating surface to be changed. Microphone M is attached to a portion of backrest upper portion 53a which is near the position of the driver's ears.

Seat state detector 54 detects the position in the forward-backward direction of seat 53 and the angle of the backrest, and outputs, as a detection result, a signal indicating the position in the forward-backward direction of seat 53 and the angle of the backrest. The signal indicating the position in the forward-backward direction of seat 53 and the angle of the backrest is an example of a signal indicating the positional relationship between the first position of speaker SP0 and the second position of microphone M. Seat state detector 54 is, for example, a sensor module which detects the position in the forward-backward direction of seat 53 and the angle of the backrest, but the specific mode of seat state detector 54 is not particularly limited. It should be noted that seat state detector 54 only has to detect at least one of the position and the incline of seat 53, and output a signal indicating at least one of the position and the incline of seat 53.

Car body 55 is a structure including the chassis, body, etc., of car 50. Car body 55 forms space 56 (cabin space) in which speaker SP0, speaker SP1, speaker SP2, and microphone M are disposed.

It should be noted that in the embodiment described below, for the convenience of description, the positions of speaker SP0, speaker SP1, speaker SP2, and microphone M are indicated in three-dimensional coordinates. The first position of speaker SP0 are (0, 0, 0), the position of speaker SP1 are (0, Y1, 0), the position of speaker SP2 are (X2, Y2, Z2), and the second position of microphone M are (X, Y, Z). Such coordinates of the second position are the coordinates when seat 53 is in the reference position, in other words, such coordinates of the second position are the coordinates when the first position of speaker SP0 and the second position of microphone M are in the reference positional relationship.

[Configuration and Basic Operation of Noise Reduction Device]

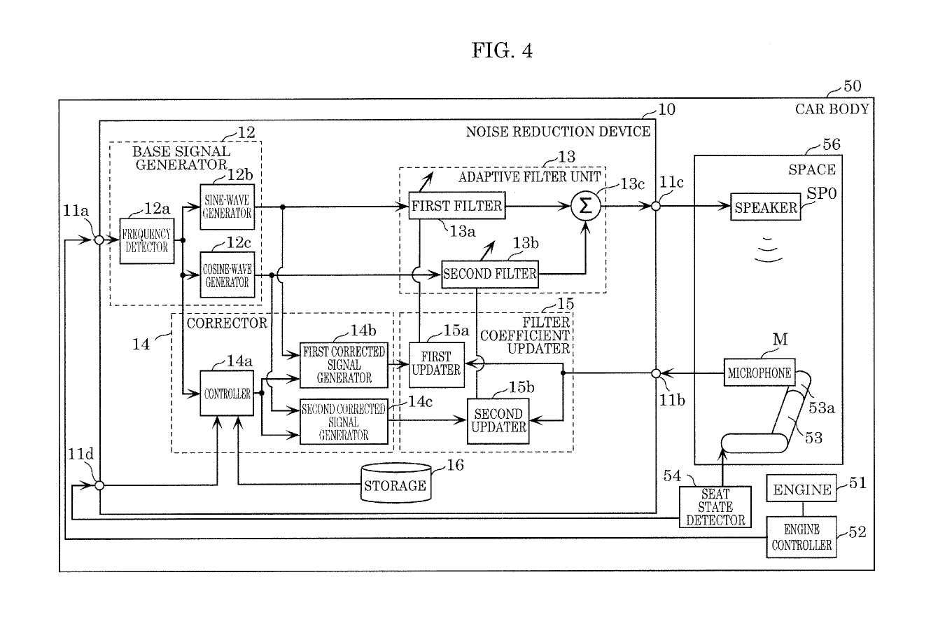

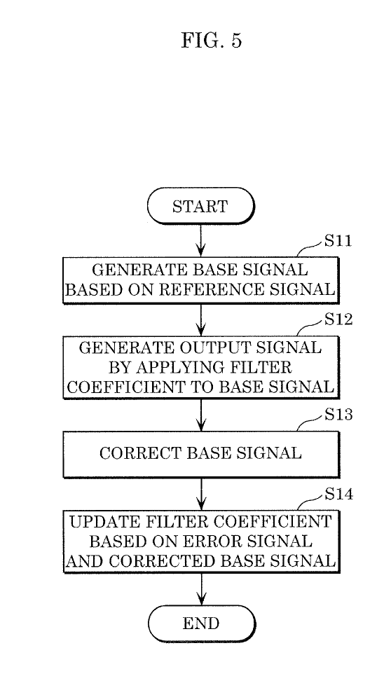

Next, a configuration and a basic operation of noise reduction device 10 will be described. FIG. 4 is a functional block diagram of noise reduction device 10. FIG. 5 is a flowchart of the basic operation of noise reduction device 10.

Noise reduction device 10 is an active noise reduction device which reduces the noise at the second position where microphone M is installed, by using the canceling sound emitted from the first position where speaker SP0 is installed. It should be noted that although noise reduction device 10 can emit the canceling sound also from speaker SP1 and speaker SP2, in the embodiment described below, the case where the canceling sound is emitted from speaker SP0 will be specifically described.

As illustrated in FIG. 4, noise reduction device 10 includes first input terminal 11a, base signal generator 12, adaptive filter unit 13, output terminal 11c, corrector 14, second input terminal 11b, filter coefficient updater 15, storage 16, and third input terminal 11d. Each of base signal generator 12, adaptive filter unit 13, corrector 14, and filter coefficient updater 15 is realized by, for example, a processor such as a digital signal processor (DSP), but may also be realized by a microcomputer or a dedicated circuit. Hereinafter, for each step described in the flowchart of FIG. 5, the relevant components will be described in detail.

[Generation of Base Signal]

First, base signal generator 12 generates a base signal based on a noise reference signal input to first input terminal 11a (S11 in FIG. 5).

First input terminal 11a is a terminal formed from metal, etc. A noise reference signal having correlation with the noise is input to first input terminal 11a. The noise reference signal is, for example, a pulse signal output by engine controller 52.

More specifically, base signal generator 12 identifies the instantaneous frequency of the noise based on the noise reference signal input to first input terminal 11a, and generates a base signal having the identified frequency. Specifically, base signal generator 12 includes frequency detector 12a, sine-wave generator 12b, and cosine-wave generator 12c.

Frequency detector 12a detects the frequency of the pulse signal, and outputs the detected frequency to sine-wave generator 12b, cosine-wave detector 12c, and controller 14a included in corrector 14. In other words, frequency detector 12a identifies the instantaneous frequency of the noise.

Sine-wave generator 12b outputs a sine wave of the frequency detected by frequency detector 12a as a first base signal. The first base signal is an example of the base signal, and is a signal expressed by sin (2πft)=sin (ωt) when the frequency detected by frequency detector 12a is denoted by f. In other words, the first base signal has the frequency identified by frequency detector 12a (same frequency as the noise). The first base signal is output to first filter 13a included in adaptive filter unit 13, and first corrected signal generator 14b included in corrector 14.

Cosine-wave generator 12c outputs a cosine wave of the frequency detected by frequency detector 12a as a second base signal. The second base signal is an example of the base signal, and is a signal expressed by cos (2πft)=cos (ωt) when the frequency detected by frequency detector 12a is denoted by f. In other words, the second base signal has the frequency identified by frequency detector 12a (same frequency as the noise). The second base signal is output to second filter 13b included in adaptive filter unit 13, and second corrected signal generator 14c included in corrector 14.

[Generation of Output Signal]

Adaptive filter unit 13 generates an output signal by applying (multiplying) a filter coefficient to the base signal generated by base signal generator 12 (S12 in FIG. 5). The output signal is used in the emission of the canceling sound for reducing the noise, and is output to output terminal 11c. Adaptive filter unit 13 includes first filter 13a, second filter 13b, and adding unit 13c. Adaptive filter unit 13 is a so-called adaptive notch filter.

First filter 13a multiplies the first base signal output by sine-wave generator 12b by a first filter coefficient. The first filter coefficient used in the multiplication is a filter coefficient corresponding to A in (Equation 2) above, and is consecutively updated by first updater 15a included in filter coefficient updater 15. A first output signal which is obtained by multiplying the first base signal by the first filter coefficient is output to adding unit 13c.

Second filter 13b multiplies the second base signal output by cosine-wave generator 12c by a second filter coefficient. The second filter coefficient used in the multiplication is a filter coefficient corresponding to B in (Equation 2) above, and is consecutively updated by second updater 15b included in filter coefficient updater 15. A second output signal which is obtained by multiplying the second base signal by the second filter coefficient is output to adding unit 13c.

Adding unit 13c adds up the first output signal output by first filter 13a and the second output signal output by second filter 13b. Adding unit 13c outputs an output signal obtained by the addition of the first output signal and the second output signal to output terminal 11c.

Output terminal 11c is a terminal formed from metal, etc. The output signal generated by adaptive filter unit 13 is output to output terminal 11c. Speaker SP0 is connected to output terminal 11c. Because of this, the output signal is output to speaker SP0 via output terminal 11c. Speaker SP0 emits the canceling sound based on the output signal.

[Correction of Base Signal]

Corrector 14 corrects the generated base signal based on first transfer characteristic C₁ of the transfer path of the output signal to generate a corrected base signal (S13 in FIG. 5). Corrector 14 includes controller 14a, first corrected signal generator 14b, and second corrected signal generator 14c.

It should be noted that first transfer characteristic C₁ is a transfer characteristic which simulates the path from the first position to the second position, when the first position of speaker SP0 and the second position of microphone M are in the reference positional relationship. Specifically, first transfer characteristic C₁ includes a gain and a phase (phase delay) per frequency. First transfer characteristic C₁ is, for example, measured in space 56 in advance for each frequency, and stored in storage 16. In other words, each frequency and the gain and phase for correcting a signal having the frequency are stored in storage 16.

Controller 14a obtains the frequency output by frequency detector 12a, reads out (selects) the gain and the phase corresponding to the obtained frequency from storage 16, and outputs the gain and the phase to first corrected signal generator 14b and second corrected signal generator 14c.

First corrected signal generator 14b corrects the first base signal based on the gain and the phase output by controller 14a to generate a first corrected base signal. The first corrected base signal is an example of a corrected base signal. When the gain output by controller 14a is denoted by α and the phase by φα, the first corrected base signal is expressed by α·sin (ωt+φα). The generated first corrected base signal is output to first updater 15a included in filter coefficient updater 15.

Second corrected signal generator 14c corrects the second base signal based on the gain and the phase output by controller 14a to generate a second corrected base signal. The second corrected base signal is an example of a corrected base signal. When the gain output by controller 14a is denoted by ß and the phase by φß, the second corrected base signal is expressed by ß·cos (ωt+φß). The generated second corrected base signal is output to second updater 15b included in filter coefficient updater 15.

Storage 16 is a storage device in which first transfer characteristic C₁ is stored. As stated above, each frequency and the gain and phase for correcting a signal having the frequency are stored in storage 16. It should be noted that first transfer characteristic C₁ may be stored in storage 16 in the form of a transfer function or a filter coefficient.

First filter coefficient A, second filter coefficient B, and others described later are also stored in storage 16. Specifically, storage 16 is realized by a semiconductor memory, etc. It should be noted that when noise reduction device 10 is realized by a processor such as a DSP, a control program executed by the processor is also stored in storage 16. Other parameters used for signal processing performed by noise reduction device 10 may also be stored in storage 16.

[Updating of Filter Coefficient]

Filter coefficient updater 15 consecutively updates the filter coefficient based on the error signal input to second input terminal lib and the generated corrected base signal (S14 in FIG. 5).

Second input terminal 11b is a terminal formed from metal, etc. An error signal based on the residual sound generated at the second position of microphone M due to the interference between the canceling sound and the noise is input to second input terminal lib. The error signal is output by microphone M.

Specifically, filter coefficient updater 15 includes first updater 15a and second updater 15b.

First updater 15a calculates the first filter coefficient based on the first corrected base signal obtained from first corrected signal generator 14b and the error signal obtained from microphone M. Specifically, First updater 15a calculates the first filter coefficient, using the LMS method so that the error signal becomes smallest, and outputs the calculated first filter coefficient to first filter 13a. Furthermore, first updater 15a consecutively updates the first filter coefficient. When the first corrected base signal is denoted by r₁ and the error signal by e, first filter coefficient A (corresponding to A in (Equation 2) above) is expressed by (Equation 3) below. It should be noted that n is a natural number and corresponds to a sampling period. Here, μ is a scalar quantity and a step size parameter which determines an update amount of the filter coefficient per sampling.

[Math. 2]

A(n)=A(n−1)−μ·r₁(n)·e(n) (Equation 3)

Second updater 15b calculates the second filter coefficient based on the second corrected base signal obtained from second corrected signal generator 14c and the error signal obtained from microphone M. Specifically, second updater 15b calculates the second filter coefficient, using the LMS method so that the error signal becomes smallest, and outputs the calculated second filter coefficient to second filter 13b. Furthermore, second updater 15b consecutively updates the second filter coefficient. When the second corrected base signal is denoted by r₂ and the error signal by e, second filter coefficient B (corresponding to B in (Equation 2) above) is expressed by (Equation 4) below.

[Math. 3]

B(n)=B(n−1)−μ·r₂(n)·e(n) (Equation 4)

[Correction of First Transfer Characteristic]

First transfer characteristic C₁ is an optimal transfer function when the first position of speaker SP0 and the second position of microphone M are in the reference positional relationship, but cannot be considered an optimal transfer function when the first position of speaker SP0 and the second position of microphone M are in a different positional relationship from the reference positional relationship because of a change in the incline and the position of seat 53. Therefore, when the first position of speaker SP0 and the second position of microphone M are in a different positional relationship from the reference positional relationship, it is possible that a sufficient reduction effect cannot be obtained if the canceling sound is emitted using first transfer characteristic C₁.

In view of this, corrector 14 (more specifically, controller 14a; the same applies below) in noise reduction device 10 performs the correction of first transfer characteristic C₁ read out from storage 16. For example, corrector 14 corrects first transfer characteristic C₁ according to the distance from the first position of speaker SP0 to the second position of microphone M. Here, when seat 53 is in the reference state, microphone M is in the reference position, and the first position and the second position are in the reference positional relationship, the coordinates of the first position are (0, 0, 0) and the coordinates of the second position are (X, Y, Z). In this case, first distance D1 from the first position to the second position is expressed by (Equation 5) below.

[Math. 4]

D1=\sqrt{X²+Y²+Z²} (Equation 5)

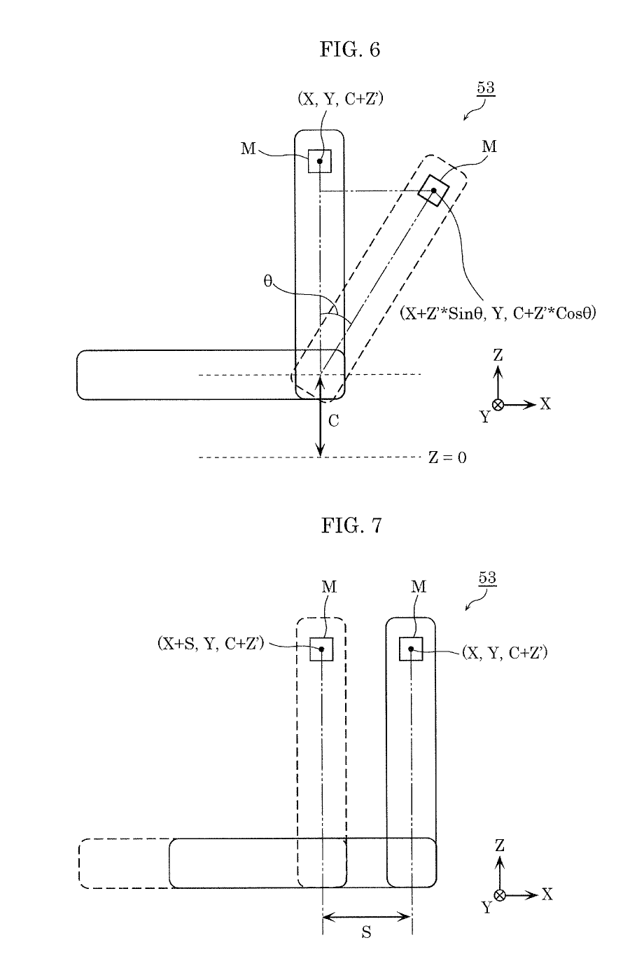

On the other hand, when the backrest of seat 53 is tilted by an angle θ with respect to the reference state where the angle formed between the backrest of seat 53 and the seating surface is 90 degrees, the coordinates of the second position are calculated as in FIG. 6. FIG. 6 is a diagram illustrating the coordinates of the second position when the backrest of seat 53 is tilted relative to the seating surface.

It should be noted that, as illustrated in FIG. 6, in the embodiment below, for the purpose of simplifying the calculation, when the distance from the position of Z=0 to the center of rotation of the backrest is denoted by C, Z is expressed by C+Z′. Specifically, when the first position and the second position are in the reference positional relationship, the coordinates of the second position are (X, Y, C+Z′), and first distance D1 is expressed by (Equation 6) below.

[Math. 5]

D1=\sqrt{X²+Y²+(C+Z′)²} (Equation 6)

As illustrated in FIG. 6, when the backrest of seat 53 is tilted by an angle θ with respect to the reference state, the coordinates of the second position are (X+Z′ sin θ, Y, C+Z′ cos θ).

On the other hand, FIG. 7 is a diagram illustrating the coordinates of the second position when the position of seat 53 is shifted by shift amount S in the forward-backward direction (specifically, in the X-axis direction). In this case, the coordinates of the second position are (X+S, Y, C+Z′).

As described above, when the backrest of seat 53 is tilted by an angle θ with respect to the reference state and the position of seat 53 is shifted by shift amount S in the forward-backward direction (specifically, in the X-axis direction), the coordinates of the second position are (X+Z′ sin θ+S, Y, C+Z′ cos θ). Second distance D2 from the first position to the second position in this case is expressed by (Equation 7) below.

[Math. 6]

D2=X+Z′ sin θ+S)²Y+Y²+(C+Z′ cos θ)² (Equation 7)

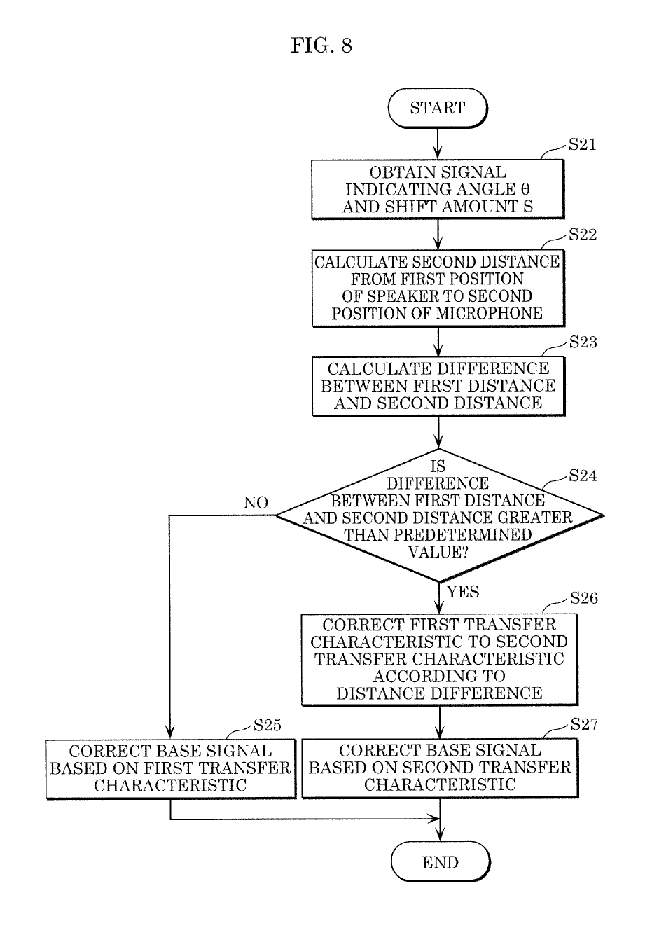

Corrector 14 calculates second distance D2 described above, and corrects first transfer characteristic C₁ to second transfer characteristic C₂ based on the calculated second distance D2. FIG. 8 is a flowchart of the correction of first transfer characteristic C₁.

First, corrector 14 obtains a signal indicating an angle θ and shift amount S from seat state detector 54 via third input terminal 11d (S21). Corrector 14 obtains the signal indicating an angle θ and shift amount S through, for example, controller area network (CAN). Third input terminal 11d is a terminal formed from metal, etc. The signal indicating an angle θ and shift amount S is input to third input terminal 11d, as a signal indicating the positional relationship between the first position and the second position.

Next, corrector 14 identifies an angle θ and shift amount S based on the signal indicating an angle θ and shift amount S, and calculates second distance D2 from the first position of speaker SP0 to the second position of microphone M based on (Equation 7) above (S22). Subsequently, corrector 14 calculates the difference between first distance D1 when the first position and the second position are in the reference positional relationship, and the calculated second distance D2 (S23), and determines whether the calculated difference is greater than a predetermined value or not (S24). Here, the difference between first distance D1 and second distance D2 is, for example, an absolute value of the difference between first distance D1 and second distance D2, and the predetermined value is, for example, a value greater than 0.

When the difference between first distance D1 and second distance D2 is determined to be less than the predetermined value (No in S24), it is possible that a certain level of noise reduction effect can be obtained even when the canceling sound is emitted using first transfer characteristic C₁ without change. In view of this, corrector 14 corrects the base signal based on first transfer characteristic C₁ (S25). In other words, corrector 14 corrects the base signal using first transfer characteristic C₁ stored in storage 16 directly, without correcting first transfer characteristic C₁.

On the other hand, when the difference between first distance D1 and second distance D2 is determined to be greater than or equal to the predetermined value (Yes in S24), it is possible that a sufficient reduction effect cannot be obtained if the canceling sound is emitted using first transfer characteristic C₁ without change. In view of this, corrector 14 corrects first transfer characteristic C₁ to second transfer characteristic C₂ (S26), and corrects the base signal based on second transfer characteristic C₂ (S27).

Specifically, corrector 14 corrects first transfer characteristic C₁ to second transfer characteristic C₂ by changing the correction amount for the phase included in first transfer characteristic C₁ according the difference between first distance D1 and second distance D2. For example, when the correction amount for the phase included in first transfer characteristic C₁ is φ1 for a base signal of 200 Hz, first transfer characteristic C₁ is corrected to second transfer characteristic C₂ by changing correction amount φ1 for the phase included in first transfer characteristic C₁ to φ1+Δφ1. In other words, correction amount φ2 for the phase included in second transfer characteristic C₂ for the base signal of 200 Hz is φ1+Δφ1.

Here, phase difference Δφ1 is obtained by calculation, as described below. Arrival time t1 of the canceling sound to the second position when the first position and the second position are in the reference positional relationship is expressed by D1/340 using the speed of sound which is 340 [m/S]. On the other hand, when the backrest of seat 53 is tilted by an angle θ with respect to the reference state and the position of seat 53 is shifted by shift amount S in the forward-backward direction, arrival time t2 of the canceling sound to the second position is expressed by D2/340.

Then, phase difference Δφ1 is expressed by (Equation 8) below. It should be noted that in (Equation 8), f is the frequency of the base signal.

$$[ Math . 7 ]$$

$$Δφ1 = 2 π f ( - ( t 2 - t 1 ) ) = \frac{20 π}{17} ( - D 2 + D 1 ) \qquad ( Equation 8 )$$

As described above, when corrector 14 corrects first transfer characteristic C₁ read out from storage 16 to second transfer characteristic C₂ and then corrects the base signal based on second transfer characteristic C₂, noise reduction effect can be obtained even when the second position significantly changes from the reference position. Furthermore, although a tremendous amount of data of transfer characteristics is needed in a configuration in which a plurality of sets of transfer characteristics are stored in storage 16 in advance and the transfer characteristics are switched according to a change in the positional relationship between the first position and the second position, in noise reduction device 10, an amount of memory necessary for storage 16 can be reduced, compared with the configuration described above.

### Variations, Etc.

The operation described with reference to the flowchart in FIG. 8 is an example. For example, corrector 14 calculates second distance D2 in Step S22, and calculates the difference between first distance D1 and second distance D2 in Step S23. However, storage 16 may hold information (for example, table information) that associates (i) an angle θ and shift amount S and (ii) the difference between first distance D1 and second distance D2 when seat 53 is in the state of an angle θ and shift amount S described above with each other in advance, and corrector 14 may identify the difference between first distance D1 and second distance D2 by referring to the information. In other words, it is not essential that the difference between first distance D1 and second distance D2 is calculated.

Furthermore, phase difference Δφ1 may also be identified by referring to information stored in storage 16. For example, when the difference between first distance D1 and second distance D2 is denoted by X, storage 16 may hold information (for example, table information) that associates X and phase correction coefficient p(X) with each other in advance. In this case, corrector 14 can calculate phase difference Δφ1 based on (Equation 9) below, when the phase correction coefficient corresponding to difference X between first distance D1 and second distance D2 is identified. It should be noted that correction amount φ2 is calculated based on (Equation 10) below.

[Math. 8]

Δϕ1=p(X)·f (Equation 9)

ϕ2=ϕ1+p(X)·f (Equation 10)

As described above, when the information stored in storage 16 in advance is referred to, an amount of calculation in the correction of first transfer characteristic C₁ can be reduced. Furthermore, the amount of memory necessary for storage 16 can be reduced, compared with the configuration in which storage 16 holds a plurality of sets of transfer characteristics.

[Advantageous Effects, Etc.]

Generally, in a noise reduction device, an output signal for emitting a canceling sound is generated, taking into consideration the transfer characteristic from the speaker position to the microphone position. When the positional relationship between the speaker and the microphone changes, however, a sufficient reduction effect cannot be obtained or control may become unstable, thereby causing a phenomenon such as increased sound. On the other hand, noise reduction device 10 is a noise reduction device which reduces noise at the second position by using the canceling sound emitted from the first position. Noise reduction device 10 includes: first input terminal 11a to which a noise reference signal having correlation with the noise is input; base signal generator 12 which generates a base signal having a frequency identified based on the noise reference signal that has been input; adaptive filter unit 13 which generates an output signal used for emission of the canceling sound, by applying a filter coefficient to the base signal that has been generated; output terminal 11c to which the output signal that has been generated is output; second input terminal lib to which an error signal based on a residual sound generated at the second position due to interference between the canceling sound and the noise is input; third input terminal 11d to which a signal indicating a positional relationship between the first position and the second position is input; corrector 14 which corrects, to second transfer characteristic C₂, first transfer characteristic C₁ for when the first position and the second position are in a reference positional relationship, according to the signal indicating the positional relationship, and corrects the base signal based on second transfer characteristic C₂; and filter coefficient updater 15 which updates the filter coefficient based on the error signal that has been input and the base signal that has been corrected.

Accordingly, first transfer characteristic C₁ is corrected to second transfer characteristic C₂ according to a signal indicating the positional relationship between the first position and the second position, and thus noise reduction effect can be obtained even when the positional relationship between the first position and the second position changes. In other words, noise reduction device 10 can produce noise reduction effect without control becoming unstable even when the positional relationship between speaker SP0 and microphone M changes.

Furthermore, for example, corrector 14 corrects first transfer characteristic C₁ to second transfer characteristic C₂ according to the difference between first distance D1 from the first position to the second position when the first position and the second position are in the reference positional relationship, and second distance D2 from the first position to the second position determined according to the signal indicating the positional relationship.

As described above, noise reduction effect can be obtained by the correction of first transfer characteristic C₁ to second transfer characteristic C₂ according to the difference between first distance D1 and second distance D2.

Furthermore, for example, corrector 14 corrects first transfer characteristic C₁ to second transfer characteristic C₂ by changing a correction amount for the phase included in first transfer characteristic C₁ according to the difference between first distance D1 and second distance D2.

Accordingly, noise reduction effect can be obtained by changing the correction amount for the phase, even when the positional relationship between the first position and the second position changes.

Furthermore, for example, corrector 14 corrects first transfer characteristic C₁ to second transfer characteristic C₂ and corrects the base signal based on second transfer characteristic C₂ when the difference between first distance D1 and second distance D2 is greater than a predetermined value, and corrects the base signal based on first transfer characteristic C₁ when the difference between first distance D1 and second distance D2 is less than or equal to the predetermined value.

Accordingly, the correction of first transfer characteristic C₁ is performed only when it is possible that the difference between first distance D1 and second distance D2 is greater than the predetermined value, and thus the amount of calculation for the correction can be reduced and noise reduction effect can be efficiently obtained.

Furthermore, for example, noise reduction device 10 further includes storage 16 that holds information that associates a phase correction coefficient and the difference between first distance D1 and second distance D2 with each other. Corrector 14 identifies phase correction coefficient p(X) corresponding to the difference between first distance D1 and second distance D2 by referring to the information stored in storage 16, and changes the correction amount for the phase included in first transfer characteristic C₁ by an amount obtained by multiplying the frequency of the base signal by phase correction coefficient p(X) that has been identified.

Accordingly, the amount of calculation in the correction of first transfer characteristic C₁ can be reduced.

Furthermore, car 50 includes: noise reduction device 10; speaker SP0 which is disposed at the first position and outputs the canceling sound using the output signal; and microphone M which is disposed at the second position and outputs the error signal to second input terminal 11b. Car 50 is an example of a vehicle, speaker SP0 is an example of a sound emission device, and microphone M is an example of a sound collection device.

Accordingly, first transfer characteristic C₁ is corrected to second transfer characteristic C₂ according to the signal indicating the positional relationship between the first position and the second position, and thus noise reduction effect can be obtained even when the positional relationship between the first position and the second position changes.

Furthermore, for example, car 50 further includes: seat 53 including one of a backrest and a headrest, to which speaker SP0 is attached; and seat state detector 54 which detects at least one of the position and the incline of seat 53, and outputs a detection result as the signal indicating the positional relationship.

Accordingly, even when the position of seat 53, the incline of the backrest, etc., change, noise reduction effect can be obtained.

Furthermore, for example, the present disclosure may be realized as a noise reduction method. The noise reduction method is a noise reduction method of reducing noise at a second position by using a canceling sound emitted from a first position. The noise reduction method includes: generating a base signal having a frequency identified based on a noise reference signal having correlation with the noise; generating an output signal used for emission of the canceling sound, by applying a filter coefficient to the base signal that has been generated; correcting, to second transfer characteristic C₂, first transfer characteristic C₁ for when the first position and the second position are in a reference positional relationship, according to a signal indicating a positional relationship between the first position and the second position, and correcting the base signal based on second transfer characteristic C₂; and updating the filter coefficient based on an error signal based on a residual sound generated at the second position due to interference between the canceling sound and the noise, and the base signal that has been corrected.

Accordingly, first transfer characteristic C₁ is corrected to second transfer characteristic C₂ according to the signal indicating the positional relationship between the first position and the second position, and thus noise reduction effect can be obtained even when the positional relationship between the first position and the second position changes.

### Other Embodiments

Although an embodiment is described thus far, the present disclosure is not limited to the foregoing embodiment.

For example, although the correction amount for the phase included in the first transfer characteristic is changed in the foregoing embodiment, the correction amount for the gain included in the first transfer characteristic may be changed or the step size parameter may be changed. Furthermore, although the correction of the first transfer characteristic is performed based on the difference between the first distance and the second distance in the foregoing embodiment, the correction of the first transfer characteristic may be performed based on only the second distance. Specifically, for example, the first transfer characteristic may be corrected based on information that associates the second distance and a phase correction coefficient with each other.

For example, although the first position of the speaker is fixed and the second position of the microphone varies in the foregoing embodiment, the first position of the speaker may vary and the second position of the microphone may be fixed. For example, the speaker may be attached to the seat, and the microphone may be attached to the dashboard, etc. Furthermore, both of the first position of the speaker and the second position of the microphone may vary.

Furthermore, at least one of the speaker and the microphone may be attached to a portion other than the seat. For example, at least one of the speaker and the microphone may be attached to a structure with at least one of a position and an incline that changes according to the operation of the user.

The noise reduction device according to the foregoing embodiment may also be mounted on a vehicle other than a car. The vehicle may be, for example, an aircraft or a marine vessel. Furthermore, the present disclosure may also be realized as a vehicle other than a car described above.

Furthermore, although an engine is taken as an example of a noise source in the foregoing embodiment, the noise source is not particularly limited. The noise source may be a motor, for example.

Furthermore, the configuration of the noise reduction device according to the foregoing embodiment is an example. For example, the noise reduction device may include such a component as a D/A converter, a low-pass filter (LPF), a high-pass filter (HPF), a power amplifier, or an A/D converter.

Furthermore, the processes performed by the noise reduction device according to the foregoing embodiment are an example. For example, part of the processes described in the foregoing embodiment may be realized by analog signal processing instead of digital signal processing.

Furthermore, for example, in the foregoing embodiment, a process performed by a certain processing unit may be performed by a different processing unit. Furthermore, the order of a plurality of processes may be changed or a plurality of processes may be performed in parallel.

Furthermore, in the foregoing embodiment, each component may be realized by the configuration of dedicated hardware or by executing a software program suitable for each component. Each component may be realized by the readout and execution of a software program recorded in a recording medium such as a hard disk or a semiconductor memory by a program executer such as a CPU or a processor.

Furthermore, each component may be a circuit (or an integrated circuit). The circuits may constitute a single circuit as a whole, or may be individual circuits. Furthermore, each of the circuits may be a general-purpose circuit, or may be a dedicated circuit.

Furthermore, an overall or specific aspect of the present disclosure may be realized by a system, a device, a method, an integrated circuit, a computer program, or a computer-readable non-transitory recording medium such as a CD-ROM. Furthermore, an overall or specific aspect of the present disclosure may also be realized by any combination of a system, a device, a method, an integrated circuit, a computer program, or a computer-readable non-transitory recording medium.

For example, the present disclosure may also be realized as a noise reduction method performed by a noise reduction device (DSP), or may also be realized as a program for causing a computer (DSP) to execute the noise reduction method described above. Furthermore, the present disclosure may be realized as a noise reduction method including the noise reduction device according to the foregoing embodiment, a speaker (sound emission device), and a microphone (sound collection device).

Furthermore, the order of the plurality of processes in the operation of the noise reduction device described in the foregoing embodiment is an example. The order of the plurality of processes may be changed, or the plurality of processes may be performed in parallel.

The present disclosure includes, for example, forms that can be obtained by various modifications to the respective embodiments and variations that may be conceived by those skilled in the art, and forms obtained by arbitrarily combining elements and functions in the respective embodiments without departing from the essence of the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosures of the following Japanese Patent Applications including specification, drawings and claims are incorporated herein by references on their entirety: Japanese Patent Application No. 2017-175035 filed on Sep. 12, 2017.

### INDUSTRIAL APPLICABILITY

The noise reduction device according to the present disclosure is useful as a device for reducing cabin noise, for example.

1. A noise reduction device which reduces noise at a second position by using a canceling sound emitted from a first position, the noise reduction device comprising:
a first input terminal to which a noise reference signal having correlation with the noise is input;
a base signal generator which generates a base signal having a frequency identified based on the noise reference signal that has been input;
an adaptive filter unit which generates an output signal used for emission of the canceling sound, by applying a filter coefficient to the base signal that has been generated;
an output terminal to which the output signal that has been generated is output;
a second input terminal to which an error signal based on a residual sound generated at the second position due to interference between the canceling sound and the noise is input;
a third input terminal to which a signal indicating a positional relationship between the first position and the second position is input;
a corrector which corrects a first transfer characteristic to a second transfer characteristic, according to the signal indicating the positional relationship, and corrects the base signal based on the second transfer characteristic, the first transfer characteristic being a transfer characteristic for when the first position and the second position are in a reference positional relationship; and
a filter coefficient updater which updates the filter coefficient based on the error signal that has been input and the base signal that has been corrected.

2. The noise reduction device according to claim 1, wherein
the corrector corrects the first transfer characteristic to the second transfer characteristic according to a difference between a first distance from the first position to the second position when the first position and the second position are in the reference positional relationship, and a second distance from the first position to the second position determined according to the signal indicating the positional relationship.

3. The noise reduction device according to claim 2, wherein
the corrector corrects the first transfer characteristic to the second transfer characteristic by changing a correction amount for a phase included in the first transfer characteristic according to the difference between the first distance and the second distance.

4. The noise reduction device according to claim 3, further comprising:
a storage that holds information that associates a phase correction coefficient and the difference between the first distance and the second distance with each other, wherein
the corrector identifies the phase correction coefficient corresponding to the difference between the first distance and the second distance by referring to the information stored in the storage, and changes the correction amount for the phase included in the first transfer characteristic by an amount obtained by multiplying the frequency of the base signal by the phase correction coefficient that has been identified.

5. The noise reduction device according to claim 2, wherein
the corrector:
corrects the first transfer characteristic to the second transfer characteristic and corrects the base signal based on the second transfer characteristic when the difference between the first distance and the second distance is greater than a predetermined value; and
corrects the base signal based on the first transfer characteristic when the difference between the first distance and the second distance is less than or equal to the predetermined value.

6. A vehicle, comprising:
the noise reduction device according to claim 1;
a sound emission device which is disposed at the first position and outputs the canceling sound using the output signal; and
a sound collection device which is disposed at the second position and outputs the error signal to the second input terminal.

7. The vehicle according to claim 6, further comprising:
a seat including one of a backrest and a headrest, to which the sound collection device is attached; and
a seat state detector which detects at least one of a position and an incline of the seat, and outputs a detection result as the signal indicating the positional relationship.

8. A noise reduction method of reducing noise at a second position by using a canceling sound emitted from a first position, the noise reduction method comprising:
generating a base signal having a frequency identified based on a noise reference signal having correlation with the noise;
generating an output signal used for emission of the canceling sound, by applying a filter coefficient to the base signal that has been generated;
correcting a first transfer characteristic to a second transfer characteristic, according to a signal indicating a positional relationship between the first position and the second position, and correcting the base signal based on the second transfer characteristic, the first transfer characteristic being a transfer characteristic for when the first position and the second position are in a reference positional relationship; and
updating the filter coefficient based on an error signal based on a residual sound generated at the second position due to interference between the canceling sound and the noise, and the base signal that has been corrected.
